(19) United States
(12) Patent Application Publication
(10) Pub. No.: US 2008/0273531 A1
(43) Pub. Date: Nov. 6, 2008

(54) DATA SWITCH AND A METHOD OF SWITCHING

(75) Inventors: Ian David JOHNSON, Ferring (GB); Colin Martin Duxbury, Stockport (GB)

Correspondence Address: PILLSBURY WINTHROP SHAW PITTMAN, LLP, P.O. BOX 10500, MCLEAN, VA, 22102, US

(73) Assignee: XYRATEX TECHNOLOGY LIMITED, Havant (GB)

(21) Appl. No.: 12/114,042

(22) Filed: May 2, 2008

Related U.S. Application Data
(60) Provisional application No. 60/924,189, filed on May 3, 2007.

(51) Int. Cl. H04L 12/28

(52) U.S. Cl. 370/390

(57) ABSTRACT

The present invention relates to a switch and a method of switching for switching data frames. The switch comprises plural input ports and plural output ports; a central switch fabric configurable in any switching cycle to make connections between required pairs of the input ports and output ports; one or more transmit devices configured to receive data from the input ports and transmit data cells across the switch fabric; a controller for controlling the operation of the transmit devices, the plural input ports and output ports and the switch fabric; and multicast storage associated with the or each of the transmit devices for storage of fragmenting multicast cells and onward transmission of the fragmented cells.

### CROSS REFERENCE TO RELATED APPLICATIONS

This application claims priority to U.S. provisional application Ser. No. 60/924,189, filed May 3, 2007, the entire contents of which is incorporated by reference herein in its entirety.

The present invention relates to a data switch and a method of switching. In a particular example, the data switch is a crossbar switch which comprises a number of external input and output port devices (TP). In use, such a switch may typically be connected within a network of other like switches to enable transmission of data frames across the network via the individual switches acting as nodes within the network.

Such a switch is known and typically includes a central crossbar switch matrix comprising plural transmit (TX) devices, with the switch being able to open any combination of simultaneous input to output connections as required. The configuration of the switch is controlled dynamically by a master control device referred to herein as a TM device. In use, the TM device receives connection requests from and issues connection grants to the input and output port devices TP.

Typically, a data frame will be made up of plural data cells, a data frame being a unit of data according to any particular communications protocol and a data cell being a constituent part of a data frame. As used herein a data cell is a smaller part of a data frame, of a size to correspond to the primary scheduling granularity for the switch.

A known difficulty in the routing of data within such switches is encountered when multicast connections are desired, i.e. one source TP to multiple destination TPs. Broadcast communication is one particular example of a multicast connection in which a single source TP is connected to all outputs TPs. Multicast connections are particularly difficult to schedule efficiently in the presence of other unicast (one-to-one) connections. One known method for achieving such multicast connection requires the storage of a multicast frame within a source TP until it had been transmitted to each recipient TP in a series of unicast connections. However, such an approach is very wasteful of switch core bandwidth, particularly for high fanout multicasts. If each multicast is sent to ten recipients, each cell must be sent ten times from the source TP to the required TX devices. If just 10% of user port bandwidth comprises such traffic, these cells use up 100% of the switch core bandwidth from TP to TX.

Crossbar switches of this type are inherently capable of creating one-to-many connections. An improved scheme therefore adds multicast arbitration capability to the TM device. If each multicast connection were to be transmitted to all its recipients simultaneously, TP to TX bandwidth utilisation reduces back to 10% in the above example. Switch efficiency is poor however due to overlapping multicast destination sets. Considering a simple example, if four multicasts each include the same destination, each cell for that destination must be sent in a separate connection cycle.

Recent research has shown that to efficiently switch multicast connections the connection must be fragmented, meaning that different sets of recipients of a given cell are able to receive that cell in different connection cycles according to demand for access to each recipient. Unfortunately, if multicasts are retained in the source port TP and retransmitted for each fragment, the previous problem of excess TP-TX core bandwidth consumption is encountered which restricts user port bandwidth.

According to a first aspect of the present invention, there is provided a switch for switching data frames, the switch comprising plural input ports and plural output ports a central switch fabric configurable in any clock cycle to make connections between required pairs of the input ports and output ports; one or more transmit devices configured to receive data from the input ports and transmit data cells across the switch fabric; a controller for controlling the operation of the transmit devices, the plural input ports and output ports and the switch fabric; and multicast storage associated with the or each of the transmit devices for storage of fragmenting multicast cells and onward transmission of the fragmented cells.

By providing storage associated with the transmit devices, the core bandwidth of the switch may be utilised extremely efficiently since whatever the fanout of a multicast connection, each cell must only be transferred between the TP device and the TX devices a single time. Thus, this enables the switch to support full line-rate bandwidth of any traffic including multicast or broadcast connections. In practice, the TP would transmit the cell for the first (or only) fragment and then delete the cell. If the multicast is not completed by this connection, the TX device retains the cell for later retransmission. Therefore, provided the recipient ports are not over utilised, the switch is capable of supporting full line-rate bandwidth of multicast connections.

According to a second aspect of the present invention, there is provided a method of switching data frames across a multi-input port and multi-output port switch, the switch comprising a central switch fabric configurable to make connections between required pairs of the input ports and output ports and one or more transmit devices configured to receive data from the input ports and transmit data cells across the switch fabric, the method comprising upon receipt at an input port of a multicast data frame, splitting the data frame into constituent data cells, transferring the data cells to storage associated with a transmit device associated with the input port at which the data frame was received; in successive cycles transferring the data cells to the plural output ports required by the multicast transmission when each of the required output ports is able to receive one or more data cells.

Again, the method of switching data frames provided enables full line-rate bandwidth to be supported by the switch irrespective of the fanout of the multicast connections. In contrast to known methods, whereby a severe limitation on the line-rate is introduced when multicast connections are made, particularly in the presence of unicast connections, in the current method it is possible to maintain full line-rate bandwidth irrespective of multicast fanout.

Preferably, the method comprises storing the received data frame at the storage as plural constituent cells and transmitting each of the cells to the corresponding output ports when possible.

Preferably also, the method comprises incrementing a write pointer each time a cell is written to the storage to enable identification of the next location in the storage at which a cell should be written.

Thus, a simple and robust method is provided by which the multicast routing of data frames can be controlled in such a way as to enable full line-rate bandwidth to be supported.

Examples of the present invention will now be described with reference to the accompanying drawings, in which:

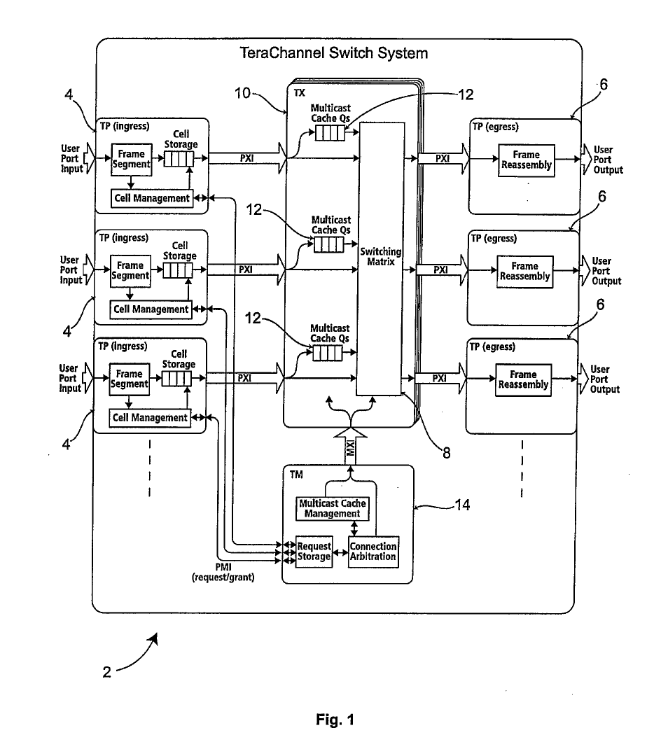

FIG. 1 shows a schematic representation of a switch;

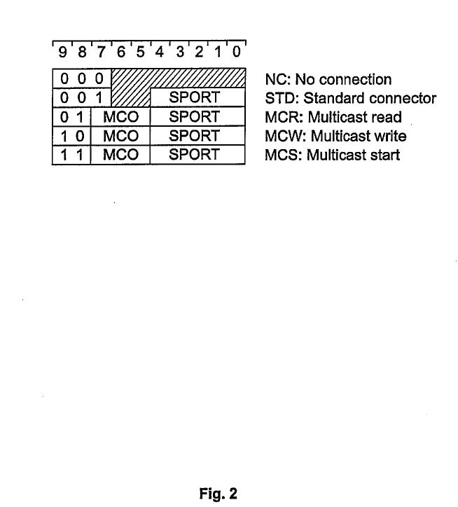

FIG. 2 shows a logical view of an example of a multicast cache for an ingress port in a transmit device of the switch of FIG. 1;

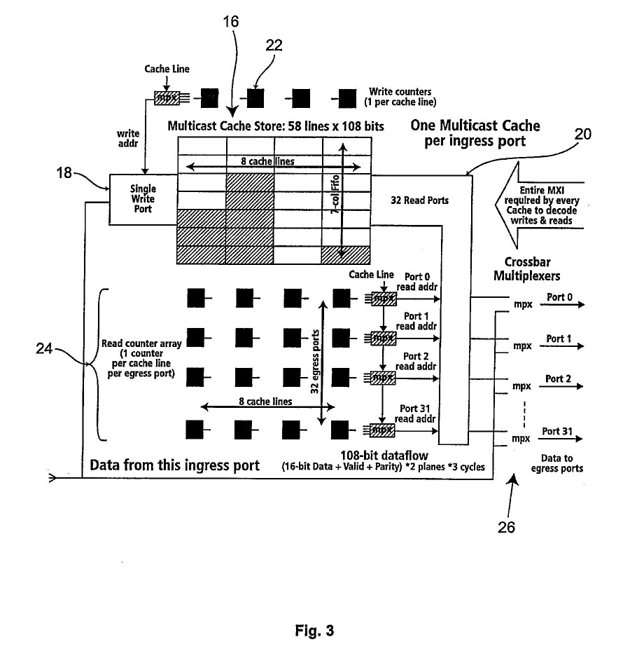

FIG. 3 shows a first example of a multicast cache;

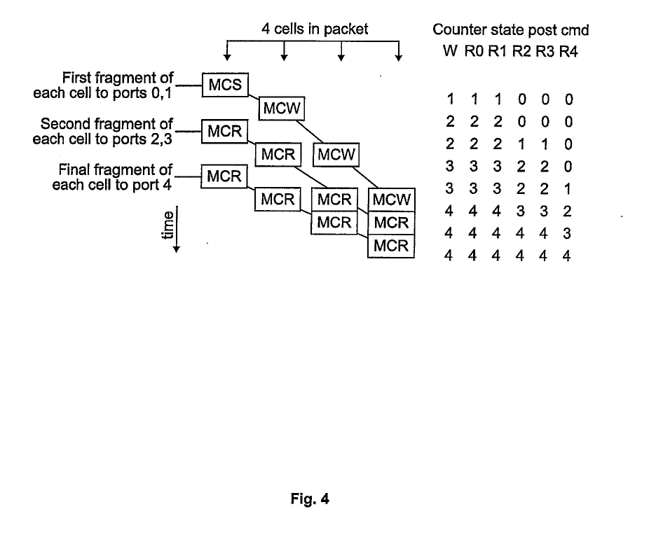

FIG. 4 shows a further example of a multicast cache example; and

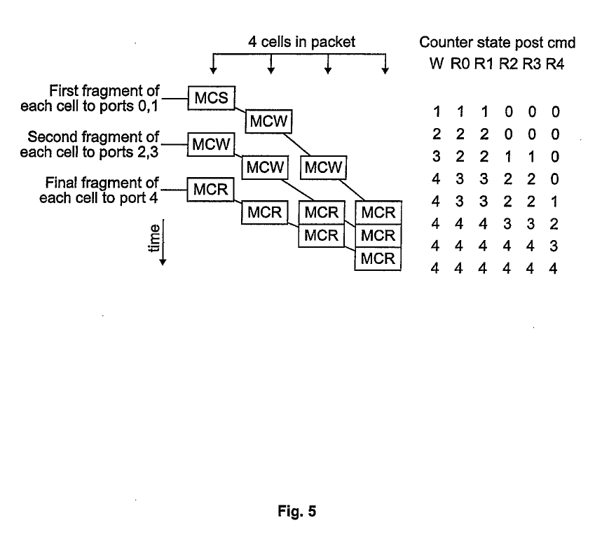

FIG. 5 shows an example of a control interface for use in the switch of FIG. 1.

FIG. 1 shows a schematic architectural representation of a switch. The switch 2 comprises plural external input ports TP 4 and plural external output ports TP 6. Three of each are shown in FIG. 1 but it will be appreciated that any required number can be provided. A central switch fabric 8 is provided (shown schematically in FIG. 1) and is configurable to enable data received from any of the input ports 4 to be routed to any of the output ports 6. A plurality of transmit devices TX 10 are provided. In the example shown, there is a TX device 10 associated with the external input ports 4. Plural TX devices 10 may be provided each associated with one or more of the input ports. Storage 12 is provided associated with each of the transmit devices 10. As will be explained below, the storage 12 enables the core bandwidth of the switch 2 to be used much more efficiently and in practice enables multicast traffic to be routed through the switch at full line-rate.

The example of the switch shown in FIG. 1 is schematic and much simplified. Other components may be present but are not shown or described herein for reasons of clarity.

It can be seen that a switch of a configuration shown in FIG. 1 overcomes the TP-TX bandwidth problem referred to above by allowing the TX devices to store fragmenting multicast cells. The external ports 4 need to transmit the cell only for the first fragment of the multicast destinations, after which the cell can be deleted. If the multicast is not completed by the first connection, the storage at the TX device retains the cell for later retransmission. Therefore, provided the recipients are not over utilised, the switch can support full line-rate bandwidth of any traffic, including multicast connections.

Typically each TX device switches only a portion of each passing cell. No one TX device therefore sees sufficient of the cell to decode even if the cell is a multicast cell, let alone if the current fragment is incomplete. This is because typically the switch core is divided into layers, which each switch their own fraction/portion of the data vector/cell, and which all share a common out of band control interface (MXI) that supplies the matrix configuration data. There would be a substantial loss of data bandwidth if any additional fractional data path signalling were allowed.

The switch also has a master (TM) device 14. The TM device 14 provides control of the switch and preferably has full knowledge of the multicast fragmentation. It is therefore able to control the cell storage at the storage 12 via an interface between the TM device and the TX devices (the interface being referred to herein as the MXI interface).

In use, when a new data frame arrives at one of the ingress ports 4, it is split up into appropriately sized packets or cells. Typically a switch core will have to transfer a finite quantity of information i.e. number of bytes, per cycle. In order to achieve the required throughput rates this tends to become the primary scheduling granularity for the switch. All data frames arriving, unless as with ATM they are of a fixed size which typically matches the core proportions, are subdivided into smaller parts referred to herein as “cells”, which will each pass through the core on a cycle-by-cycle basis.

Referring to FIG. 2, a schematic representation of the MXI interface is shown. The MXI interface serves to convey the connection configuration of the crossbar matrix 8 for each arbitration cycle of the switch. The interface is unidirectional from the master device TM to the matrix and, in this particular example, comprises ten signals per egress port.

In the examples shown, one-to-one connections are indicated by an STD command, which instructs the egress port to connect itself to the input port specified by the SPORT field. This manner of configuration allows multiple egress ports to easily connect to the same egress port to permit multicast and broadcast connections. The remaining commands control access to and from the storage within the transmit device associated with any particular input port and is used for multicast data. The MCS command creates a normal connection and writes the first cell for a new multicast frame. The MCW command does the same for the rest of the frame's cells, and the MCR command reads the written data without creating an ingress port connection. In the examples shown, these commands are written in binary form within the master matrix interface. A full description of the multicast caching hardware will be provided below.

In one example, the connection configuration for a thirty two port switch is conveyed in two 8 ns clock periods, on a bundle of eleven unidirectional 2.5 Gbaud serial links. If the switch cycle is configured to be more than two clock cycles, no MXI data is transmitted after the first two cycles.

FIG. 3 shows a schematic representation of the hardware typically used within a TX device for providing the necessary storage of data frames and cells. It is preferred that the storage 12 for data cells is provided within cache memory provided at each of the TX devices.

Referring to FIG. 3, the cache 16 is provided as an eight cache line seven cell FIFO able to hold all the cells for a single frame of the size 512 bytes and any associated headers. The cache 16 includes a single write port 18 and thirty two independently addressable read ports 20 for each of the thirty two egress ports or output ports 6 of the switch. Of course, the number of ports in this example is selected for use with a thirty two egress port switch. In practice the number of read ports of the cache is selected to correspond to the number of output ports of the switch in which the cache is provided.

In the examples shown, the multicast cache 16 implements storage for multicast cells sourced from a single ingress port to allow the system to offer wire-speed multicast from that port in the presence of connection fragmentation.

Within one TX device, each cache stores just that device's contribution to cells from that ingress port. Each switch or TX device typically would include thirty two such caches, one for each ingress port. Again, what is important is that the number of caches corresponds to the number of ingress ports 4 of the switch. The caches are shown as discrete units. It is to be understood that the unit may be a logical discrete unit within a larger shared memory.

The TM control 14 controls the cache line allocation and read/write process via the MXI interface. Multicast cells which can be sent to all their recipients in a single connection have no need for this facility. They may be connected by the master TM issuing a normal STD connection to the egress ports which will receive the cell. TX will then connect these egresses to the source port indicated by their SPORT field, as described above.

For a new multicast connection which is fragmenting, the master TM will first choose a free line in the TX multicast cache associated with the source port of the request. The frame will typically be broken up into cells to enable control of the routing of the data within the switch. The first connection for the first cell of the newly received frame is created by the TM control 14 issuing an MCS command to the egress ports receiving the first fragment. MCS creates a normal STD-type ingress egress connection to provide bypass data to the reading ports, and is then passed to the ingress ports multicast cache.

A number of counters are provided to enable the correct cache line to be accessed and the correct cell within each cache line to be written to or read from during the receipt and transmission of the multicast frame.

As shown in FIG. 3, a number of write counters 22 are provided. A single write counter is typically provided per cache line so that a dedicated counter is able to provide the required data regarding where the next cell for a particular cache line should be written.

A number of read pointers 24 is also provided. A read pointer is provided per cache line per egress port so as to provide an example of a mechanism for keeping track of whether a multicast connection has decomposed, i.e. been fully transmitted, to all of its designated destinations. A number of crossbar multiplexers 26 are provided to provide a physical data path for the required cells through the fabric of the switch and on to the required output ports 6.

As data is received in a multicast cache, the write and read counters for the chosen cache line (indicated by the MCQ value), causes the cell data to be written into the head of the cache line's FIFO. The single write address counter for that cache line is incremented, and the read address counter for each port which is receiving the MCS is incremented since these ports are being sent the first cell in this connection.

The first connection for each subsequent cell of the same frame is handled by a MCW command. This behaves in a similar manner to the MCS command except that no counters are reset, and the cell data is written into the FIFO line indicated by the write counter value. Simultaneously with issuing both MCS and MCW commands, the master TM issues a grant signal to the source TP to command it to send the required cell to the switch fabric. For every cell, data to the first set of recipients is preferably obtained directly from the ingress port TP. In other words the multicast cache is written but not read. This is for reasons of speed and efficiency.

For every subsequent connection fragment of any cell, TM issues no grant commands to the input port. Rather, a MCL command is sent to the TX device egress ports receiving that fragment. This command is then passed to the ingress port sourcing the data. For each egress port in the fragment, the read counter for that combination of port and cache line is selected, the cache is read at that address, the data is routed to the requesting port and the read counter is incremented. Thus, the read counters and write counters provide a convenient and robust manner by which control of the multicast cache routing can be achieved.

FIG. 4 shows one example of a sequence by which four cells of a data frame are stored within a multicast cache and their onwards transmission controlled by the various commands described above. As can be seen, the frame is to be multicast to each of the five ports 0 to 4. Initially, an MCS command is sent indicating that the multicast cache is to start. The use of multiple read counters is particularly advantageous as it allows the overlapping of read sequences. In the example shown in FIG. 4, the second and third fragments are simultaneously reading different cells from the cache. The table of numbers to the right of the commands shows that the write and read counter states after the issue of the command. Thus, in the first line the write counter is incremented to show that the cell from the first fragment of the frame is routed to the output ports 0 and 1.

On the second cycle, the second cell from the data frame is written to the cache line. Again, the second cell is read to the 0th and first output ports. At this stage, no data has yet been sent to any of the second, third or fourth output ports. Presumably, in the switching cycles so far used up, these ports where not free to receive the cells.

Next, in the third row, the first data cell is read to the second fragment, i.e. to read ports 2 and 3. In the next cycle, the third cell is written to the cache line and the third cell is read to the 0th and first ports simultaneously with the reading of the second cell to the second and third ports. It can be seen that the process proceeds until all of the cells of the data frame have been read to each of the five output ports. By this stage, the cache line will be empty.

FIG. 5 shows a further example of the command sequence and counter state post commands within a switch such as that shown in FIG. 1 when using the multicast caches. In this example, egress ports receiving an MCW command are always sent data cells, normally the cell being written as described above. Where however the ports read counter lags the common write counter value, the port will perform an implied MCR to obtain the next cell in its sequence, ignoring the data being written by the MCW. Thus, it becomes possible for the master to issue an MCW to load a cell into the MCQ, where no egress ports are receiving that cell in this arbitration cycle. The cell will be retrieved later by an MCR (or MCW) command. This strategy allows greater freedom for the master to create cut-through sequences.

In one specific example, in order to implement thirty two independent read ports, the cache will utilise eight dual port register files, each sixty four lines by seventy two bits wide, double-rate clocked at 250 MHz. The extra lines (only fifty six are actually used) ease the segregation into eight cache lines and the detection of access violations. In one arbitration cycle, each copy will perform up to one write on its write port (the same write to all eight copies), and up to four time multiplexed reads on its read port.

A cyclic redundancy check (CRC check) on the MXI interface is sometimes performed. When this fails, the entire MXI may be nullified for the effected arbitration cycle. Normal STD connections will suffer straightforward cell loss, but operations on the multicast cache are more complex. If only the erroring MXI is lost, the following happens to the MCR, MCW and MCS commands.

When there is MCR loss, the read counter for the port losing the MCR will fail to increment, so that the next MCR for that egress port will send the cell which should have been sent by the current MCR. The last cell in the frame will not be sent and effected egress output ports or frame recipients will discard the too-short frame.

When there is a loss of an MCW command, the current cell being sent by the input port will be lost. The write counter will therefore be one less than it should be, and ports later reading cells by MCR will attempt to read one more cell than is actually stored. The TX device will send no data and will report an error and the egress port will again drop the cell. All multicast recipients will trash their received packets which are to-short.

When there is a loss of a MCS command, this is most serious, since the reset of the counters to clear the cache line of its old contents is lost. Uncorrected cells belonging to previous packets are likely to be sent and if the number of cells matches the packet header, the packet will be forwarded by the output port in good faith. Such an undetected data corruption is clearly unacceptable.

To guard against the above, the default action on MXI CRC fail will be to block access to all cache lines or ingress ports. A blocked cache will ignore writes and supply no data for any reads. Blocking will persist on each line for each port until an MCS is received for that line and port. Only after the resulting counter resets can the integrity of that line be guaranteed. An MXI CRC fail will thus result in serious multicast packet loss. In some examples, should this prove unacceptable, a configurable mode can be set to limit the effect of such a failure to nullifying of the failing configuration only, at the expense of potential undetected frame corruption.

Embodiments of the present invention have been described with particular reference to the examples illustrated. However, it will be appreciated that variations and modifications may be made to the examples described within the scope of the present invention.

1. A data switch for switching data packets, the switch comprising:
plural input ports and plural output ports
a central switch fabric configurable in any switching cycle to make connections between one or more required pairs of the input ports and output ports;
one or more transmit devices configured to receive data from the input ports and transmit data across the switch fabric;
a controller for controlling the operation of the transmit devices, the plural input ports and output ports and the switch fabric; and
storage associated with the or each of the transmit devices for storage of fragmenting multicast data and onward transmission of the fragmented data.

2. A switch according to claim 1, wherein one or more of the input ports comprise a frame segmenter arranged to divide a data frame received at the respective input port into data cells for onward routing of the cells through the switch.

3. A switch according to claim 1, comprising a control interface between the plural input ports and the controller for enabling the communication of control information therebetween.

4. A switch according to claim 1, comprising a control interface between the plural transmit devices and the controller for enabling the communication of control information therebetween.

5. A switch according to claim 1, in which the storage is cache memory.

6. A switch according to claim 5, in which the cache comprises plural lines, each for the storage of the cells of a fragmenting multicast data frame.

7. A switch according to claim 5, wherein each transmit device has a data receiving port for receiving data from an input port and a data transmission port for onwards routing of data to a corresponding required output port.

8. A switch according to claim 5, comprising for each transmit device, a cache line index write pointer for each line in the cache for determining where in the respective cache line a received data cell should be written.

9. A switch according to claim 5, comprising plural read counter pointers, one for each output port associated with each transmit device for determining which next data cell should be read from any one cache line for a respective port and thereby maintaining a record of which data cells have been sent to which output ports.

10. A method of switching data packets across a multi-input port and multi-output port data switch, the data switch comprising a central switch fabric configurable to make connections between required pairs of the input ports and output ports and one or more transmit devices configured to receive data from the input ports and transmit data across the switch fabric, the method comprising:
upon receipt at an input port of a multicast data frame, transferring the data frame to storage associated with a transmit device associated with the input port at which the data frame was received;
in successive cycles transferring the data frame to the plural output ports required by the multicast transmission when each of the required output ports is able to receive the packet.

11. A method according to claim 10, comprising dividing a received data frame into data cells and routing these across the switch.

12. A method according to claim 10, comprising storing the received data frame at the storage as plural constituent cells and transmitting each of the cells to the corresponding output ports when possible.

13. A method according to claim 12, comprising incrementing a write pointer each time a cell is written to the storage to enable identification of the next location in the storage at which a cell should be written.

14. A method according to claim 11, comprising incrementing a read pointer each time a cell is transmitted to a respective output port to keep track of when a complete frame is transferred and the multicast transmission has been completed.
